(19) United States
(12) Patent Application Publication
(10) Pub. No.: US 2005/0282552 A1
(43) Pub. Date: Dec. 22, 2005

(54) Media mixing using wireless devices

(76) Inventors: Atul N. Hatalkar, Chandler, AZ (US); Cory Cox, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/871,201

(22) Filed: Jun. 18, 2004

(51) Int. Cl. H04Q 7/20

(52) U.S. Cl. 455/450

(57) ABSTRACT

Data stream mixing using at least one wireless device capable of receiving data transmitted according to a first wireless communication protocol and also capable of transmitting data according to a second wireless communication protocol.

### TECHNICAL FIELD

Embodiments of the invention relate to wireless communications. More particularly, embodiments of the invention relate to mixing of audio signals transmitted by a wireless communication device, for example, a cellular telephone.

### BACKGROUND

Using current wireless communications devices (e.g., cellular telephones and other cellular-enabled devices) and protocols users can communicate using traditional voice communication protocols and techniques. Current wireless communications devices and protocols also provide the ability to transmit and receive data files. However, in some situations, wireless users may desire additional functionality, for example, the ability to mix media content to transmit via the wireless communications device. Current wireless communications devices and protocols do not support this functionality.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a high-level diagram of one embodiment of an architecture that may support real-time media mixing using wireless devices and multiple wireless communication protocols.

FIG. 2 is a flow diagram of one embodiment of approximately real-time mixing using multiple wireless protocols.

FIG. 3 is a block diagram of one embodiment of a wireless communications device.

FIG. 4 is a block diagram of one embodiment of an electronic system.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

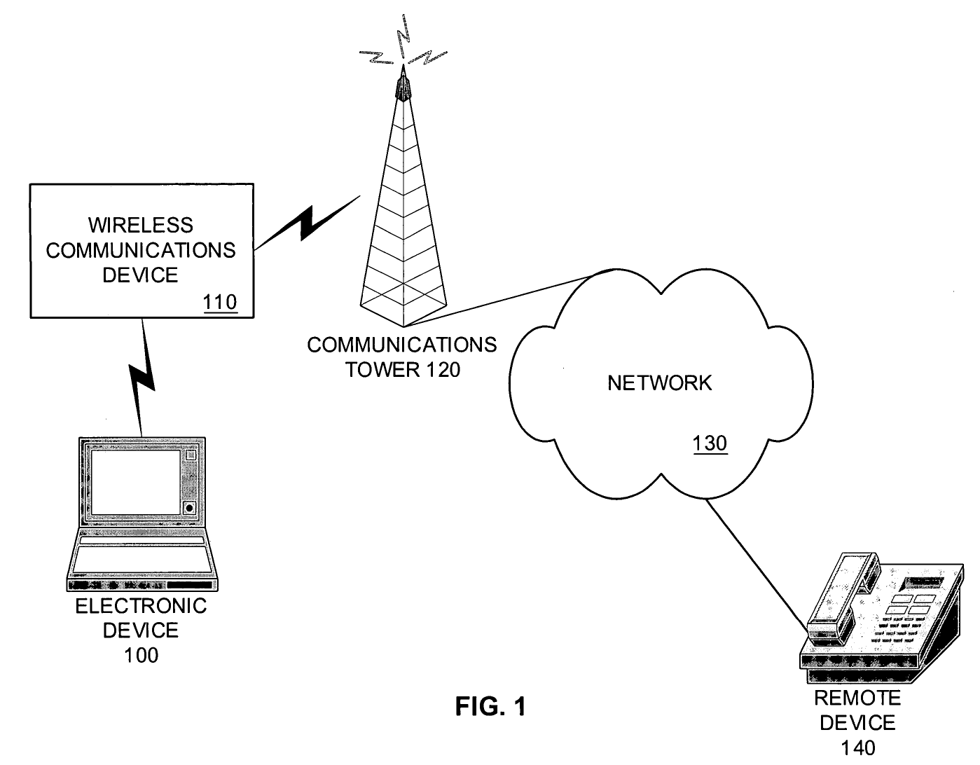

FIG. 1 is a high-level diagram of one embodiment of an architecture that may support real-time media mixing using wireless devices and multiple wireless communication protocols. The components of FIG. 1 are intended to represent a broad range of wireless communications protocols and corresponding devices as well as a broad range of media sources and content, and not intended to be limited to the specific protocols and devices explicitly described.

Wireless communications device 110 may be any type of wireless communications device known in the art. For example, wireless communications device 110 may be a cellular telephone. Wireless communications device 110 can communicate using any wireless protocol known in the art. Wireless communications device 110 may be configured to communicate with wireless communications tower 120 that may also communicate with other wireless communications devices (not shown in FIG. 1).

Examples of wireless communications protocols that can be used with wireless communications device 110 may include, for example, a Time Division, Multiple Access (TDMA) protocols, a Global System for Mobile Communications (GSM) protocols, a Code Division, Multiple Access (CDMA) protocols, or any other type of wireless communications protocol. Wireless communications device 110 can be any type of wireless device that allows a user to communicate with a remote device, which may include, for example, a cellular telephone, a cellular-enabled personal digital assistant (PDA), a cellular-enabled vehicle, other cellular-enabled devices or other radio frequency, microwave, or infrared communications devices, etc.

In one embodiment, wireless communications tower 120 may be coupled with network 130 over a wired and/or a wireless communications link. Communication between wireless communications tower 120 and remote device 140 over network 130 may be accomplished in any manner known in the art. Wireless communications tower 120 is intended to represent any type of base station or repeater known in the art and is not required to be a tower.

In one embodiment, a user engaged in voice communications using wireless communications device 110 (e.g., a cellular telephone, or other cellular-enabled device) may, for example, wish to share an audio file (e.g., music, previously recorded spoken words, recordings of events) or other type of file with remote device 140. Using previous technology and protocols, the sharing of the audio file would be independent of the channel used to carry the voice communications. That is, the audio file could not be mixed with the voice communications signal in a manner that would provide good sound quality. In one embodiment, wireless communications device 110 may receive the audio file from electronic device 100. In an alternate embodiment, wireless communications device 110 may store the audio file that has been received from electronic device 100.

As an example use of the audio mixing, a user of a cellular telephone (an example of wireless communications device 110) may be engaged in a conversation with a party using a remote telephone (an example of remote device 140) using network 130 using a cellular telephone protocol (e.g., GSM). During the conversation, the user of the cellular telephone may wish to share an audio file with the remote party. The user of the cellular telephone may cause a laptop computer system (an example of electronic device 100) to transmit the audio file to the cellular telephone using, for example, Bluetooth communications protocols.

The cellular telephone can mix the received audio file (or a portion thereof) with the voice of the user as detected by the microphone of the cellular telephone, which allows the user to provide narration of the audio file as the audio file is being transmitted to the remote party. Other wireless communications devices, electronic devices and/or communications protocols can also be supported. Bluetooth protocols are described in “Specification of the Bluetooth System: Core, Version 1.1,” published Feb. 22, 2001 by the Bluetooth Special Interest Group, Inc. Associated as well as previous or subsequent versions of the Bluetooth standard may also be supported.

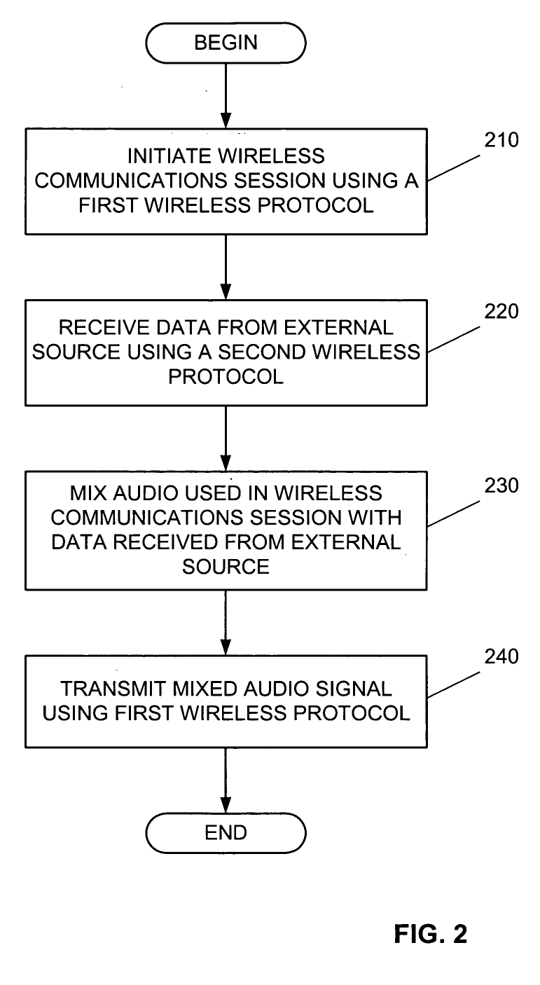

FIG. 2 is a flow diagram of one embodiment of approximately real-time mixing using multiple wireless protocols. The flow diagram of FIG. 2 provides only a single example of a use of the technique of mixing audio signals and use of multiple communications protocols. Other variations of the example of FIG. 2 may also be provided within the scope of the invention as defined by the claims that follow.

In one embodiment, a user of a wireless communications device (e.g., a cellular telephone) may initiate a communications session using a first wireless protocol, 210. This may be accomplished, for example, by a user of a cellular telephone placing a call to a receiving party using any type of cellular communications protocol known in the art, for example, GSM or TDMA. Other wireless communications devices and/or communications protocols can also be used.

The wireless communication device may receive data from an external source using, for example, a second wireless protocol, 220. Alternatively, the data may be received via a wired connection, for example, via a “dongle.” The data received from the external source may be, for example, an audio file, a video file or a text file, or any combination thereof. In one embodiment, the second wireless protocol may be a protocol that is not used for cellular communications. For example, the second wireless protocol may be a wireless local area network protocol (e.g., IEEE 802.11b or 802.11g) or the second wireless protocol may be a wireless personal area network protocol (e.g., Bluetooth). Any wireless protocol can be used. Also, any transmission technique including, for example, radio frequency, infrared, satellite, may be used.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents.

The wireless communication device may receive the data in any manner from the external source. In one embodiment, the wireless communication device may receive a complete file from the external source before further action is taken with the data. In another embodiment, the wireless communication device may receive only a portion of a complete file prior to taking further action. For example, the wireless communication device may begin receiving a streamed audio file and may take action on the received data prior to receipt of the complete file.

In one embodiment, audio signals detected by a microphone of the wireless communication device may be mixed with the data received from the external source, 230. For example, words spoken by the user of the wireless communication device may be detected by a microphone in any manner known in the art and audio, video and/or text from the received data may be mixed prior to transmission. This allows, for example, the user of a cellular telephone to transmit an audio or video file while providing commentary.

In one embodiment, the mixing may be performed in approximately real-time with respect to receipt or playback of the received file to allow the user of the wireless communications device to provide narration and/or continue a conversation. In an alternate embodiment, the mixed data may be stored by the wireless communications device for later transmission. The wireless communication device may then transmit the mixed signals using the first communication protocol, 240.

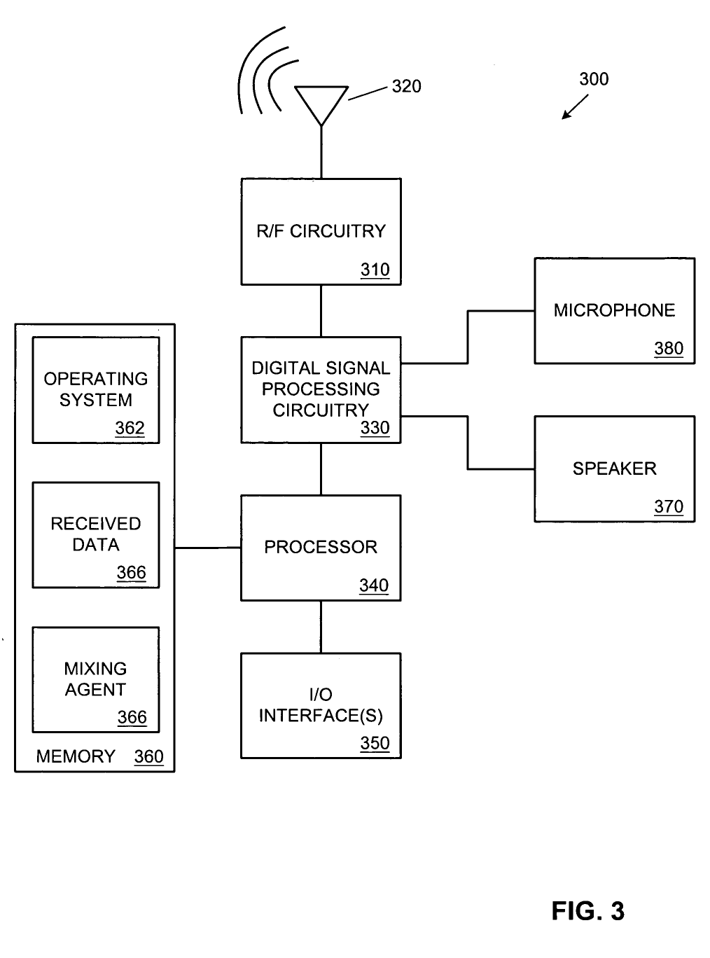

FIG. 3 is a block diagram of one embodiment of a wireless device. Wireless device 300 may be any type of wireless device that allows a user to communicate with a remote device using wireless protocols. For example, wireless device 300 can be a cellular telephone, a cellular-enabled personal digital assistant, a cellular-enabled automobile, etc.

In one embodiment, wireless device 300 may include processor 340 that provides processing functionality to support operation of the wireless device. Processor 340 may be coupled with input/output (I/O) interface(s) 350 that allow a user of wireless device 300 to provide and receive information. For example, I/O interface(s) 350 may be coupled with a keypad and/or a display device. Processor 340 may also be coupled with memory 360, which may include dynamic, static, flash and/or any other type of memory. Memory 360 can provide storage for instructions executed by processor 340 as well as data.

In one embodiment, processor 340 may be coupled with digital signal processor (DSP) circuitry 330. DSP circuitry 330 may be any type of DSP circuitry known in the art. DSP circuitry 330 may be coupled with speaker 370 and microphone 380 that may be used in transmitting of voice communications. DSP circuitry 330 may be coupled with radio frequency (R/F) circuitry 310 that may be used in receiving and transmitting radio frequency signals using antenna 320, which can be any type of antenna known in the art, for example, one or more omnidirectional antenna(e).

In one embodiment, memory 360 may include operating system 362, which provides system level software to be executed by processor 340 to control electronic system 300. Operating system 362 can be any operating system known in the art or an application-specific operating system. In one embodiment, memory 360 may include received data 366, which is intended to represent data that may be received from an external device using a wireless protocol. Received data 366 may represent audio, video and/or text that have been received from the external device. Any wireless network protocol using any type of transmission technique (e.g., radio frequency, infrared, optical, microwave).

In one embodiment, mixing agent 366 may also be included in (or coupled with) memory 360 to mix received data 366 with other data received, for example, by microphone 380. Mixing agent 366 may be implemented as hardware, software or any combination of hardware and software. In one embodiment, mixing by mixing agent 366 may be performed in approximately real-time to allow a user of wireless device 300 to, for example, provide commentary to an audio or video file being transmitted. Memory 360 may also include other applications not shown in FIG. 3.

In one embodiment, mixing agent 366 and/or other components of wireless device 300 can provide quality of service (QoS) functionality. The QoS functionality may, for example, allow a user of wireless device 300 to define quality parameters for voice communication and/or the received data file. The quality parameters may include, for example, sampling rate bounds, bandwidth bounds and/or priorities assigned to various types of data.

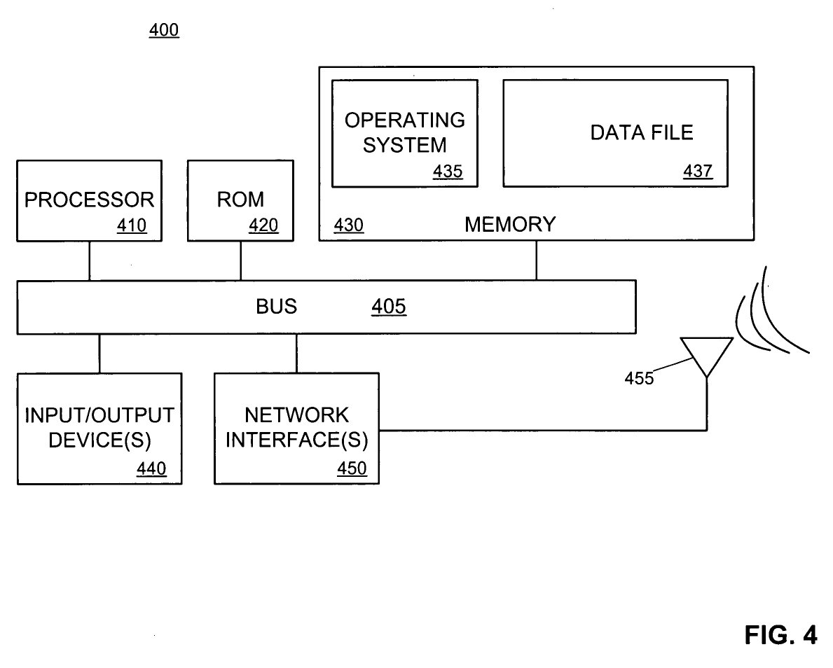

FIG. 4 is a block diagram of one embodiment of an electronic system. The electronic system illustrated in FIG. 4 is intended to represent a range of electronic systems including, for example, computer systems or personal digital assistants (PDAs). Alternative electronic systems may include more, fewer and/or different components.

In one embodiment, electronic system 400 may include bus 405 or other communication medium to communicate information, and processor 410 coupled to bus 405 to process information. While electronic system 400 is illustrated with a single processor, electronic system 400 may include multiple processors and/or co-processors. Electronic system 400 may further include read-only memory (ROM) or other static storage device 420, coupled to bus 400.

Electronic system 400 may also include input/output (I/O) device(s) 440 for receiving input data and/or signals and for providing output signals. I/O device(s) 440 may include, for example, a keyboard, a mouse, a touch screen, a liquid crystal display, a cathode ray tube, a wireless interface, or any other type of I/O device known in the art. Network interface(s) 450 may provide an interface to one or more networks (not shown in FIG. 4) that are external to electronic system 400. Network interface(s) 450 may include, for example, a wireless network interface having antenna 455, which may represent, for example, one or more omnidirectional antenna(e). In one embodiment, network interface(s) 450 may provide access to a local area network, for example, by conforming to IEEE 802.11b and/or IEEE 802.11g standards, or the wireless network interface may provide access to a personal area network, for example, by conforming to Bluetooth standards. Other wireless network interfaces and/or protocols can also be supported.

Electronic system 400 may also include memory 430 coupled with bus 405. Memory 430 may include any combination of random access memory (RAM), including one or more cache memories, and static memory, for example, a hard disk drive, a flash memory device, etc. In one embodiment, memory 430 may store operating system 435, which provides system level software to be executed by processor 410 that may control electronic system 400. Operating system 435 may be any operating system known in the art or an application specific operating system. Memory 430 may also include data file 437 that may be transmitted via network interface(s) 450 to one or more external devices that may include, for example, a cellular telephone or other cellular-enabled device. Data file 437 may include data that represents any combination of audio, video, graphics, text, etc.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method comprising:
establishing a communications channel according to a first wireless protocol between a local communications device and a remote device;
receiving a transmitted data signal from a source device with the local communications device using a second protocol; and
mixing the received data signal and an audio signal detected by a microphone of the local communications device to generate a multi-source audio signal.

2. The method of claim 1 further comprising transmitting the multi-source audio signal to the remote device using the first protocol.

3. The method of claim 1 wherein mixing the received data signal and an audio signal detected by a microphone of the local communications device to generate a multi-source audio signal comprises:
determining one or more quality of service parameters corresponding to the received data signal, the audio signal detected by the microphone and/or the multi-source audio signal; and
performing mixing of the received data signal and the signal detected by the microphone based on the one or more quality of service parameters.

4. The method of claim 1 wherein the local communications device comprises a cellular-enabled electronic device.

5. The method of claim 4 wherein the cellular-enabled electronic device comprises a cellular telephone.

6. The method of claim 1 wherein the source device comprises a computer system.

7. The method of claim 1 wherein the source device comprises an audio system.

8. The method of claim 1 wherein the second protocol comprises a personal area network protocol.

9. The method of claim 8 wherein the personal area network protocol comprises a Bluetooth protocol.

10. The method of claim 1 wherein the second protocol comprises a local area network protocol.

11. The method of claim 9 wherein the local area network protocol conforms to IEEE Std. 802.11b and/or IEEE Std. 802.11g.

12. The method of claim 1 wherein the data signal comprises data representing an audio signal.

13. The method of claim 1 wherein the data signal comprises data representing a video signal.

14. The method of claim 1 wherein the data signal comprises data representing a graphics file.

15. The method of claim 1 wherein the data signal comprises data representing a text file.

16. A wireless communications device comprising:
first wireless communication circuitry coupled with a microphone to transmit audio signals detected by the microphone to a remote device using a first wireless communication protocol;
second wireless communication circuitry coupled to receive a transmitted data signal from a transmitting device according to a second wireless communication protocol; and
a mixing circuit coupled with the first wireless communication circuitry and the second wireless communication circuitry to mix the audio signals detected by the microphone and the data signals received from the transmitting device to generate a multi-source audio signal to be transmitted to the remote device using the first wireless communication protocol.

17. The wireless communication device of claim 16 wherein the first wireless communication protocol comprises a cellular telephone communication protocol.

18. The wireless communication device of claim 16 wherein the second wireless communication protocol comprises a personal area network communication protocol.

19. The wireless communication device of claim 18 wherein the personal area network communication protocol comprises a Bluetooth protocol.

20. The wireless communication device of claim 16 wherein the second wireless communication protocol comprises a local area network communication protocol.

21. The wireless communication device of claim 20 wherein the local area network protocol conforms to IEEE Std. 802.11b and/or IEEE Std. 802.11g.

22. The wireless communication device of claim 16 wherein the mixing circuit mixes the audio signals detected by the microphone and the data signals received from the transmitting device in approximately real-time.

23. The wireless communication device of claim 16 wherein the data signal comprises data representing an audio signal.

24. The wireless communication device of claim 16 wherein the data signal comprises data representing a video signal.

25. The wireless communication device of claim 16 wherein the data signal comprises data representing a graphics file.

26. The wireless communication device of claim 16 wherein the data signal comprises data representing a text file.

27. An article of manufacture comprising a computer-readable medium having stored thereon instructions that, when executed by one or more processors, cause the one or more processors to:
establish a communications channel according to a first wireless protocol between a local communications device and a remote device;
receive a transmitted data signal from a source device with the local communications device using a second protocol; and
mix the received data signal and an audio signal detected by a microphone of the local communications device to generate a multi-source audio signal.

28. The article of claim 27 further comprising instructions that, when executed, cause the one or more processors to transmit the multi-source audio signal to the remote device using the first protocol.

29. The article of claim 27 wherein the instructions that cause the one or more processors to mix the received data signal and an audio signal detected by a microphone of the local communications device to generate a multi-source audio signal comprise instructions that, when executed, cause the one or more processors to:
determine one or more quality of service parameters corresponding to the received data signal, the audio signal detected by the microphone and/or the multi-source audio signal; and
perform mixing of the received data signal and the signal detected by the microphone based on the one or more quality of service parameters.

30. The article of claim 27 wherein the local communications device comprises a cellular-enabled electronic device.

31. The article of claim 30 wherein the cellular-enabled electronic device comprises a cellular telephone.

32. The article of claim 27 wherein the source device comprises a computer system.

33. The article of claim 27 wherein the source device comprises an audio system.

34. The article of claim 27 wherein the second protocol comprises a personal area network protocol.

35. The article of claim 34 wherein the personal area network protocol comprises a Bluetooth protocol.

36. The article of claim 27 wherein the second protocol comprises a local area network protocol.

37. The article of claim 36 wherein the local area network protocol conforms to IEEE Std. 802.11b and/or IEEE Std. 802.11g.

38. The article of claim 27 wherein the data signal comprises data representing an audio signal.

39. The article of claim 27 wherein the data signal comprises data representing a video signal.

40. The article of claim 27 wherein the data signal comprises data representing a graphics file.

41. The article of claim 27 wherein the data signal comprises data representing a text file.

42. A system comprising:
one or more substantially omnidirectional antenna(e);
first wireless communication circuitry coupled with at least one of the one or more substantially omnidirectional antenna(e) and with a microphone to transmit audio signals detected by the microphone to a remote device using a first wireless communication protocol;
second wireless communication circuitry coupled with at least one of the one or more substantially omnidirectional antenna(e) and coupled to receive a transmitted audio signal from a transmitting device according to a second wireless communication protocol; and
a mixing circuit coupled with the first wireless communication circuitry and the second wireless communication circuitry to mix the audio signals detected by the microphone and the audio signals received from the transmitting device to generate a multi-source audio signal to be transmitted to the remote device using the first wireless communication protocol.

43. The system of claim 42 wherein the first wireless communication protocol comprises a cellular telephone communication protocol.

44. The system of claim 42 wherein the second wireless communication protocol comprises a personal area network communication protocol.

45. The system of claim 44 wherein the personal area network communication protocol comprises a Bluetooth protocol.

46. The system of claim 42 wherein the second wireless communication protocol comprises a local area network communication protocol.

47. The system of claim 46 wherein the local area network protocol conforms to IEEE Std. 802.11b and/or IEEE Std. 802.11g.

48. The system of claim 42 wherein the mixing circuit mixes the audio signals detected by the microphone and the audio signals received from the transmitting device in approximately real-time.
